(19) United States
(12) Patent Application Publication
(10) Pub. No.: US 2019/0188532 A1
(43) Pub. Date: Jun. 20, 2019

(54) METHOD, APPARATUS, AND PROGRAM FOR INFORMATION PRESENTATION

(71) Applicant: FUJITSU LIMITED, Kawasaki-shi (JP)

(72) Inventor: Tetsuyoshi Shiota, Yokohama (JP)

(73) Assignee: FUJITSU LIMITED, Kawasaki-shi (JP)

(21) Appl. No.: 16/285,427

(22) Filed: Feb. 26, 2019

Related U.S. Application Data
(63) Continuation of application No. PCT/JP2016/076023, filed on Sep. 5, 2016.

(51) Int. Cl. G06K 9/62; G06F 17/18

(52) U.S. Cl. CPC G06K 9/6231; G06F 17/18; G06K 9/623; G06K 9/6232

(57) ABSTRACT

An information presentation method causes a computer to perform, among a plurality of evaluation items for each of a plurality of decision making entities, extracting one or a plurality of evaluation items that indicate features of a target decision making entity being a target specified by a user for information presentation, for each of the other decision making entities other than the target decision making entity included in the plurality of decision making entities, calculating a feature similarity degree corresponding to the extracted evaluation items and becoming higher with an increase in a degree indicating a feature of the target decision making entity and each of the other decision making entities based on the evaluation value of the evaluation item; and outputting information on the other decision making entity having the calculated feature similarity degree equal to or higher than a predetermined value to an output device.

### CROSS-REFERENCE TO RELATED APPLICATION

This application is a continuation application of International Application PCT/JP2016/076023 filed on Sep. 5, 2016 and designated the U.S., the entire contents of which are incorporated herein by reference.

### FIELD

The embodiments discussed herein are related to an information presentation method, an information presentation apparatus, and an information presentation program.

### BACKGROUND

When a local government studies administrative measures for solving its own problems, the local government sometimes refers to the measures taken by the other local governments. Alternatively, when a company studies a business plan for solving its own problems, the company sometimes refers to the businesses of the other companies, or the like. In these cases, techniques are provided for supporting such a situation.

For example, a proposal has been made of a method of selecting at least one of decision making entities having characteristics similar to those of a target decision making entity to which information is presented from a plurality of decision making entities. In this method, calculation is performed for each decision making entity on an evaluation index, which is an evaluation index for each of a plurality of evaluation items for each of a plurality of decision making entities and based on the characteristic information representing the characteristics of each decision making entity. The decision making entity to be referenced is selected based on the calculated evaluation index for each decision making entity. For example, a related-art technique is disclosed in International Publication Pamphlet No. WO 2015/064713.

As described above, when a decision making entity, such as a local government, a company, or the like refers to information on the activities of the other decision making entities, it is desirable that the decision making entity be capable of understanding its features and referring to the information on the decision making entity having solved the problem among the other decision making entities having similar features. The more distinctive the feature in the other local government, the higher the priority for referring to the information of the local government.

However, in the related art, as a method for evaluating the similarity between decision making entities, a method of utilizing a distance function using a Euclidean distance, or the like of the evaluation values for each evaluation item. That is to say, in the related art, a selection is made of the other decision making entity having similarity in the numerical evaluation value of an evaluation item, and the selection does not have to be made of a decision making entity having a more distinctive feature.

According to an embodiment of the present disclosure, it is desirable to present more distinctive feature information of the other decision making entities when a decision making entity makes a decision.

### SUMMARY

According to an aspect of the embodiments, an information presentation method causes a computer to perform, among a plurality of evaluation items for each of a plurality of decision making entities, extracting one or a plurality of evaluation items that indicate features of a target decision making entity being a target specified by a user for information presentation, for each of the other decision making entities other than the target decision making entity included in the plurality of decision making entities, calculating a feature similarity degree corresponding to the extracted evaluation items and becoming higher with an increase in a degree indicating a feature of the target decision making entity and each of the other decision making entities based on the evaluation value of the evaluation item; and outputting information on the other decision making entity having the calculated feature similarity degree equal to or higher than a predetermined value to an output device.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a functional block diagram of an information presentation apparatus according to first to fourth embodiments;

FIG. 2 is a diagram illustrating an example of an evaluation information database in the first to the third embodiments;

FIG. 3 is an explanatory diagram of a feature similarity degree in the first embodiment;

FIG. 4 is a block diagram illustrating the schematic configuration of a computer that functions as the information presentation apparatus according to the first to the fourth embodiments;

FIG. 5 is a flowchart illustrating an example of information presentation processing;

FIG. 6 is an explanatory diagram of a feature similarity degree in the second embodiment;

FIG. 7 is an explanatory diagram of a feature similarity degree in the third embodiment;

FIG. 8 is a diagram illustrating an example of an evaluation information database in the fourth embodiment;

FIG. 9 is an explanatory diagram of a feature similarity degree in the fourth embodiment;

FIG. 10 is a diagram illustrating an example of calculation of a feature similarity degree when a decision making entity is a company; and

FIG. 11 is an explanatory diagram of a comparison between calculation methods of the feature similarity degree.

### DESCRIPTION OF EMBODIMENTS

In the following, a detailed description will be given of an example of a disclosed technique according to an embodiment with reference to the drawings. In each of the following embodiments, a description will be given of an example of the case in which information is presented to a local government, which is an example of a decision making entity that performs decision making, such as policy making, strategic decision making, or the like.

### First Embodiment

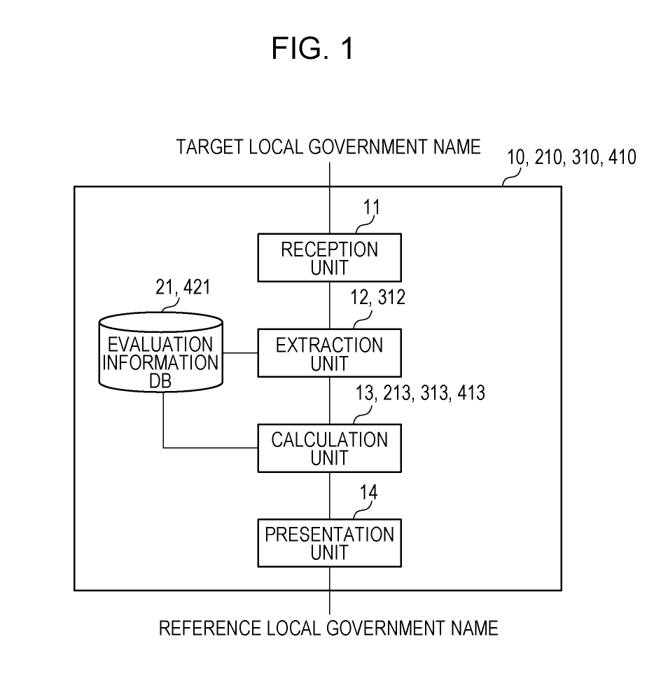

As illustrated in FIG. 1, an information presentation apparatus 10 according to a first embodiment includes a reception unit 11, an extraction unit 12, a calculation unit 13, and a presentation unit 14. A predetermined storage area in the information presentation apparatus 10 includes an evaluation information database (DB) 21.

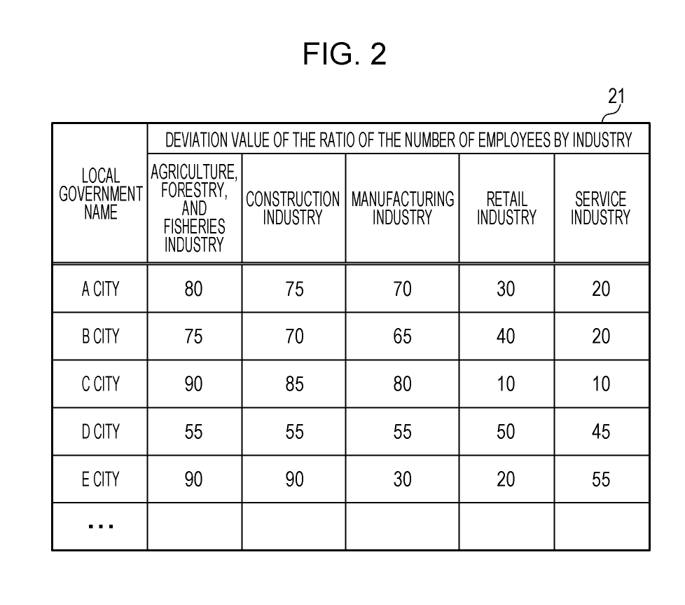

The evaluation information DB 21 stores an evaluation value for each of a plurality of evaluation items for each local government. FIG. 2 illustrates an example of the evaluation information DB 21. FIG. 2 illustrates the ratio of the number of employees by industry for each local government using a deviation value among all the local governments. Each industry is the evaluation item, and a deviation value is an example of the evaluation value. Hereinafter the deviation value of the ratio of the number of employees in a local government (hereinafter, also referred to as a “local government j”) having the local government name j for the i-th (the i-th column of the deviation value field) industry (hereinafter also referred to as “industry i”) stored in the evaluation information DB 21 is denoted by S_{i, j}. For example, the deviation value of the ratio of the number of employees in the agriculture, forestry, and fisheries industry (i=1) in A City (j=A) is denoted by S_{1, A}.

The evaluation value is not limited to a deviation value, and it is possible to use an index that is capable of indicating the degree of a feature of a local government regarding each evaluation item as an evaluation value. For example, it may be possible to use a difference value produced by subtracting the average value of all the local governments from the actual value of each local government regarding an evaluation item, or the quotient when the difference value is divided by the standard deviation, or the like. The evaluation value does not have to be a continuous value, and, for example, may be a discrete value, such as a five-grade evaluation or a 10-grade evaluation. By using such an evaluation value, it is possible to determine an evaluation item having a high evaluation value or a low evaluation value to be a distinctive feature evaluation item for the local government.

The evaluation information DB 21 is not limited to be stored in the internal storage device of the information presentation apparatus 10 and may be stored in an external storage device or a storage device of the other apparatus connected via a network.

The reception unit 11 receives the identification information of a target local government input by a user, who is a clerk, or the like of a local government (hereinafter referred to as a “target local government”) to which information is presented via an input device (illustration is omitted), such as a keyboard, a mouse, or the like connected to the information presentation apparatus 10. In the present embodiment, a description will be given of the case of using a local government name as the identification information of a local government. The reception unit 11 notifies the extraction unit 12 of the received target local government name.

The extraction unit 12 extracts one or a plurality of evaluation items that indicate the feature of the target local government indicted by the target local government name notified from the reception unit 11 and the evaluation values of the evaluation items from the evaluation information DB 21. Specifically, the extraction unit 12 extracts a predetermined number of evaluation items or the specified number of evaluation items by the user via the input device in descending order of the evaluation value. The extraction unit 12 may extract an evaluation item having an evaluation value equal to or higher than a predetermined value.

For example, it is assumed that when the evaluation information DB 21 illustrated in FIG. 2 is stored, and a target local government name “A City” has been notified from the reception unit 11. In this case, the extraction unit 12 reads all the deviation values S_{i, A} of A City from the evaluation information DB 21 and extracts an industry (evaluation item) and the deviation value (evaluation value) of the industry in descending order of the deviation values S_{i, A} up to the L-th industry. Hereinafter the industries extracted by the extraction unit 12 are referred to as feature industries tₐₖ (k=1, . . . , L) for the target local government a. The deviation value of a local government j for a feature industry tₐₖ is expressed as S_{tak, j}(k=1, . . . , L) and in particular, the deviation value of the target local government a for a feature industry tₐₖ is expressed as S_{tak, a} (k=1, . . . , L). For example, assuming that L=3, t_{A1, A}=agriculture, forestry, and fisheries industry, t_{A2}=construction industry, and t_{A3}=manufacturing industry are extracted with the deviation values S_{tA1, A}=80, S_{tA2, A}=75, and S_{tA3, A}=70 respectively as the feature industries of A City.

When an industry having a deviation value equal to or higher than a predetermined is extracted as a feature industry tₐₖ, assuming that the predetermined deviation value is, for example, “70”, the feature industry tₐₖ and the deviation value S_{tak, a} are extracted in the same manner as described above. In this case, L=3 is determined afterward. Assuming that the predetermined deviation value is, for example, “75”, t_{A1}=agriculture, forestry, and fisheries industry, and t_{A2}=construction industry are extracted with the deviation values S_{tA1, A}=80 and S_{tA2, A}=75 respectively as the feature industries of A City, and this case results in L=2.

The extraction unit 12 transfers the target local government name, the feature industry tₐₖ of the target local government a, the deviation value S_{tak, a} and the value of L to the calculation unit 13.

For each of the local governments, stored in the evaluation information DB 21, other than the target local government, the calculation unit 13 calculates a feature similarity degree that indicates to what degree their features are similar to those of the target local government. It is assumed that a feature similarity degree is a value that becomes higher as the deviation value S_{tak, a} of the target local government a and the deviation value S_{tak, j} of the other local government j indicate higher degree of the feature of the target local government a and the other local government j for each feature industry tₐₖ of the target local government a extracted by the extraction unit 12.

Specifically, the calculation unit 13 reads all the deviation values S_{i, j} of the ratio of employees by industry of the other local government j corresponding to the local government name other than the target local government name transferred from the extraction unit 12. The calculation unit 13 identifies the deviation value S_{tak, j} from the deviation value S_{i, j} of the read other local government j. The calculation unit 13 calculates the feature similarity degree Tⱼ using the identified S_{tak, j}, the feature industry tₐₖ transferred from the extraction unit 12, the deviation value S_{tak, a}, and the value of L for each other local government j, for example, by the following expression (1).

$${T}_{j} = {( \frac{{\sum }_{k = 1}^{L} ( {S}_{{t}_{ak} , a} \times {S}_{{t}_{ak} , j} )}{L} )}^{1 / 2} \qquad ( 1 )$$

The feature similarity degree Tⱼ in the expression (1) uses the product of the deviation value S_{tak, a} of the target local government a for the feature industry tₐₖ and the deviation value S_{tak, j} of the other local government j for the feature industry tₐₖ of the target local government a. That is to say, for the feature industry tₐₖ having a high deviation value S_{tak, a} of the target local government a, if the other local government j has a high deviation value S_{tak, j}, the feature similarity degree Tⱼ becomes high.

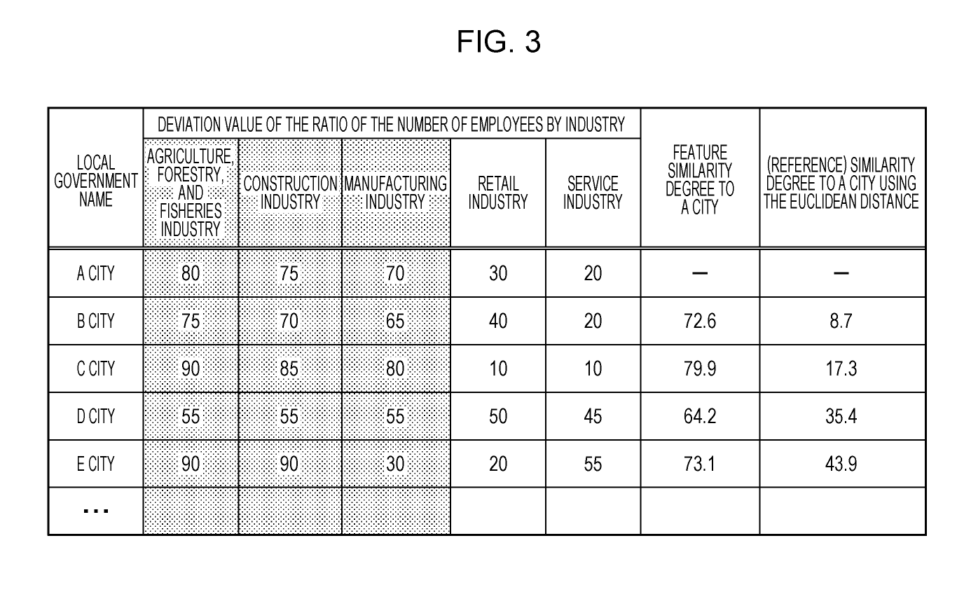

For example, it is assumed that the evaluation information DB 21 in FIG. 2 is used, and the target local government a is A City. In this case, as illustrated in FIG. 3, for A City and a local government j other than A City, a feature similarity degree Tⱼ is calculated using the deviation values (shaded portion in FIG. 3) of the three industries, namely the agriculture, forestry, and fisheries (k=1), the construction industry (k=2), and the manufacturing industry (k=3). For example, the feature similarity degree T_{B} between A City and B City becomes T_{B}=((80×75+75×70+70×65)/3)^{1/2}=72.6. In the same manner, the feature similarity degrees Tⱼ with C City, D City, and E City are calculated as T_{C}=79.9, T_{D}=64.2, and T_{E}=73.1 respectively as illustrated in FIG. 3.

The calculation unit 13 transfers the calculated feature similarity degree Tⱼ for each local government j to the presentation unit 14.

The presentation unit 14 presents names of the other local governments having the feature similarity degree Tⱼ transferred from the calculation unit 13, which is equal to or higher than a predetermined value as reference local government names.

Specifically, the presentation unit 14 determines the M-th feature similarity degree Tⱼ from the top in descending order of the feature similarity degree Tⱼ as a predetermined value, and extracts the names of the local governments having a feature similarity degree Tⱼ equal to or higher than a predetermined value, that is to say, up to the M-th local government names in descending order of the feature similarity degree Tⱼ. The presentation unit 14 presents the extracted local government name as a reference local government name with the information on the number (the M-th) of the feature similarity degree Tⱼ in size to the user by displaying the information on a display unit connected to the information presentation apparatus 10 or printing the information on a printer.

For example, when the feature similarity degrees Tⱼ between A City, which is the target local government a, and the local governments j other than A City are calculated as illustrated in FIG. 3, and if M=3, the presentation unit 14 presents information on the first C City, the second E City, and the third B City as reference local government names.

The predetermined value may be a predetermined value or a value specified by the user via the input device. In the case of FIG. 3, for example, if it is set that local governments having a feature similarity degree equal to or higher than Tⱼ=70 are extracted as reference local governments, the same reference local government names as described above are presented. If it is set that local governments having a feature similarity degree equal to or higher than Tⱼ=73 are extracted as reference local governments, only the first C City and the second E City are output.

As a reference, the rightmost column in FIG. 3 illustrates a result produced by calculating the similarity degree between A City and the other local government j using the Euclidean distance of the vector values having deviation values as elements for each feature industry. In the reference example, if reference local governments are extracted in ascending order of the Euclidean distance, the result becomes B City, C City, D City, and E City.

However, it is understood that C City has higher deviation values in the agriculture, forestry, and fisheries industry, the construction industry, and the manufacturing industry than those of A City, and these industries are more distinctive feature than those of B City. Accordingly, there is a high possibility that A City will quickly find good measures if C City is referenced prior to B City. E City has high deviation values in the agriculture, forestry, and fisheries industry and the construction industry. The two industries are said to be more distinctive features compared with D City. Accordingly, there is a high possibility that good measures will be found if E City is referenced prior to D City.

In this manner, by only using the similarity degree in numerical value of the evaluation value (deviation value) of evaluation items, it is not possible to preferentially present a local government having more distinctive features or a local government having a more distinctive feature for a part of the evaluation items.

On the other hand, in the present embodiment, a feature similarity degree is used that becomes higher as the deviation values of the target local government and each of the other local governments become higher for the feature industries of the target local government. Thus, the feature similarity degrees are listed in descending order as C City, E City, B City, and D City. Accordingly, it is possible to preferentially present a local government having more distinctive features or a local government having a more distinctive feature in a part of the evaluation items.

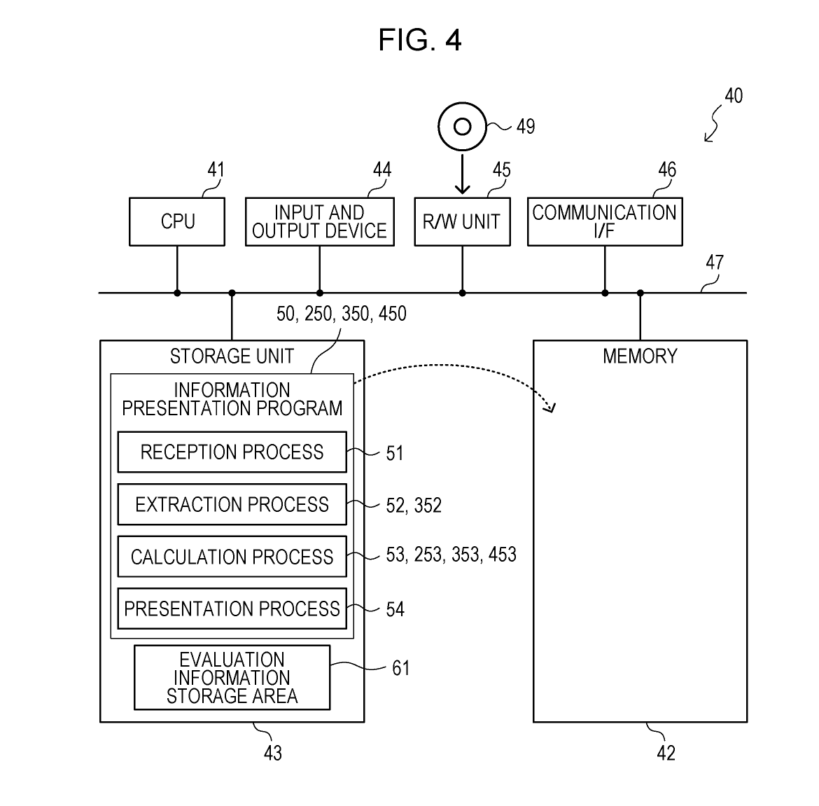

It is possible to realize the information presentation apparatus 10 by, for example, a computer 40 illustrated in FIG. 4. The computer 40 includes a central processing unit (CPU) 41, a memory 42 as a temporary storage area, and a nonvolatile storage unit 43. The computer 40 includes an input and output device 44, a read/write(R/W) unit 45 that controls reading data from and writing data to a storage medium 49, and a communication interface (I/F) 46 connected to a network, such as the Internet, or the like. The CPU 41, the memory 42, the storage unit 43, the input and output device 44, the R/W unit 45, and the communication I/F 46 are mutually connected via a bus 47. The input and output device 44 includes an output device, such as a display, a printer, or the like, and is used for displaying local government names to be presented by the present embodiment, or the like. The input and output device 44 includes an input device, such as a keyboard, a touch panel, a mouse, or the like and is used for specifying a target local government by a user, or for specifying a calculation method of a feature similarity degree.

It is possible to realize the storage unit 43 by a hard disk Drive (HDD), a solid state drive (SSD), a flash memory, or the like. As a storage medium, the storage unit 43 stores an information presentation program 50 that causes the computer 40 to function as the information presentation apparatus 10. The information presentation program 50 includes a reception process 51, an extraction process 52, a calculation process 53, and a presentation process 54. The storage unit 43 includes an evaluation information storage area 61 that stores information constituting the evaluation information DB 21.

The CPU 41 reads the information presentation program 50 from the storage unit 43, loads the information presentation program 50 into the memory 42, and executes the processes of the information presentation program 50 in sequence. The CPU 41 executes the reception process 51 so as to operate as the reception unit 11 illustrates in FIG. 1. The CPU 41 executes the extraction process 52 so as to operate as the extraction unit 12 illustrated in FIG. 1. The CPU 41 executes the calculation process 53 so as to operate as the calculation unit 13 in FIG. 1. The CPU 41 executes the presentation process 54 so as to operate as the presentation unit 14 illustrated in FIG. 1. The CPU 41 reads information from the evaluation information storage area 61 and loads the evaluation information DB 21 into the memory 42. Thereby, the computer 40 that executes the information presentation program 50 functions as the information presentation apparatus 10.

It is possible to realize the functions to be performed by the information presentation program 50 by, for example, a semiconductor integrated circuit, more specifically an application specific integrated circuit (ASIC), or the like.

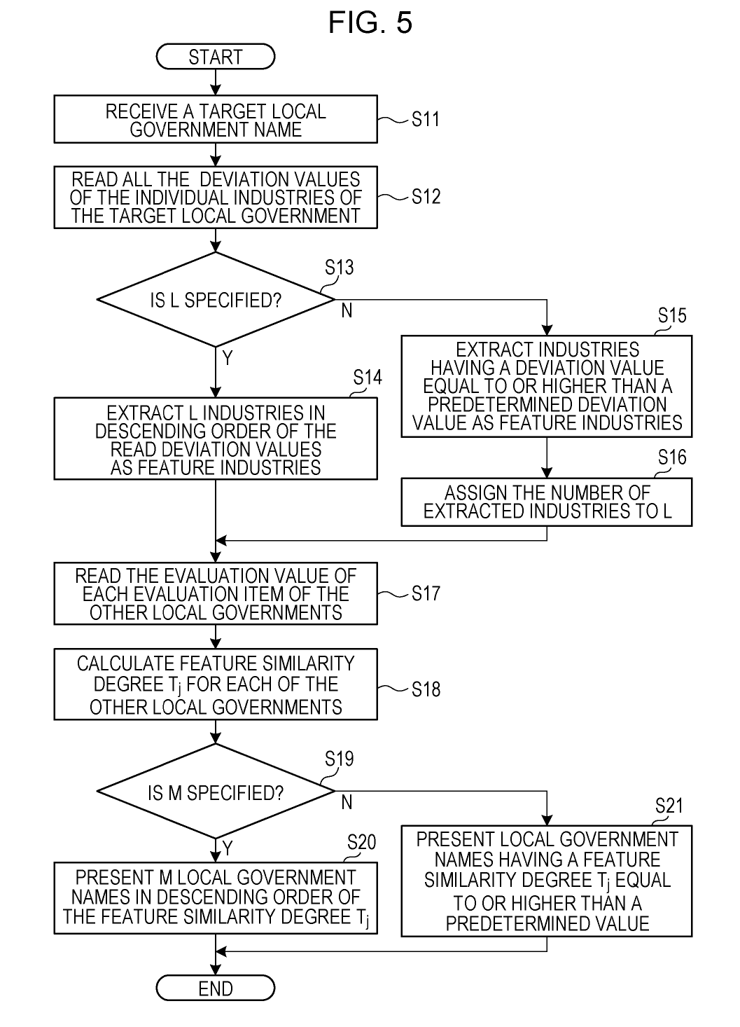

Next, a description will be given of the operation of the information presentation apparatus 10 according to the first embodiment. When a user who is a clerk, or the like of a target local government inputs a target local government name via an input device, such as a keyboard, a mouse, or the like connected to the information presentation apparatus 10, the information presentation apparatus 10 performs information presentation processing illustrated in FIG. 5.

In step S11, the reception unit 11 receives an input target local government name and notifies the extraction unit 12 of the received target local government name.

In step S12, the extraction unit 12 reads all the deviation values S_{i, a}, of each industry i for the target local government a from the evaluation information DB 21.

Next, in step S13, the extraction unit 12 determines whether or not a value L that indicates the number of feature industries to be extracted is specified. If L is specified, the processing proceeds to step S14, whereas if L is not specified, the processing proceeds to step S15.

In step S14, the extraction unit 12 extracts up to the L-th industries having the deviation value S_{i, A} read in the above-described step S12, in descending order, as feature industries tₐₖ with the deviation values S_{tak, a}, and the processing proceeds to step S17.

On the other hand, in step S15, the extraction unit 12 extracts industries having a deviation value equal to or higher than a predetermined deviation value as feature industries tₐₖ with its deviation values S_{tak, a}. Next, in step S16, the extraction unit 12 sets the number of extracted feature industries tₐₖ in L, and the processing proceeds to step S17.

In step S17, the extraction unit 12 transfers the target local government name, the feature industries tₐₖ of the target local government a, the deviation values S_{tak, a}, and the value of L to the calculation unit 13. The calculation unit 13 reads all the deviation values S_{i, j} of the ratio of the number of employees by industry of the other local governments j corresponding to the local government names other than the target local government name transferred from the extraction unit 12.

Next, in step S18, the calculation unit 13 identifies a deviation value S_{tal, j} from the read deviation values S_{i, j} of the other local governments j. The calculation unit 13 calculates a feature similarity degree Tⱼ for each of the local governments j using the identified deviation value S_{tal, j}, and the feature industry tₐₖ, the deviation value S_{tak, a}, and the value of L that have been transferred from the extraction unit 12, for example, by the expression (1). The calculation unit 13 transfers the calculated feature similarity degree Tⱼ for each local government j to the presentation unit 14.

Next, in step S19, the presentation unit 14 determines whether or not a value M that indicates the number of the reference local government names to be presented is specified. If M is specified, the processing proceeds to step S20, whereas if M is not specified, the processing proceeds to step S21.

In step S20, the presentation unit 14 extracts up to the M-th local government names having a feature similarity degree Tⱼ in descending order and presents the extracted local government names as reference local government names with the information on the number (the M-th) in size of the feature similarity degree Tⱼ to the user, and the information presentation processing is terminated.

On the other hand, in step S21, the presentation unit 14 extracts the names of the local governments having a feature similarity degree Tⱼ equal to or higher than a predetermined value and presents the extracted local government names as reference local government names to the user with the information on the number (the M-th) in size of the feature similarity degree Tⱼ to the user, and the information presentation processing is terminated.

As described above, with the information presentation apparatus 10 according to the first embodiment, a feature similarity degree is calculated using the evaluation value (deviation value) of the evaluation item (feature industry) having a distinctive feature of a target decision making entity (target local government). A feature similarity degree is a value that becomes higher as each of the evaluation values of the target decision making entity and the other decision making entities becomes higher for an evaluation item having a distinctive feature. Accordingly, it is possible to present the information (name of the decision making entity, or the like) on the other decision making entity having a more distinctive feature using the feature similarity degree.

In the first embodiment, a feature similarity degree is calculated using the product of the evaluation value of the target decision making entity and the evaluation value of the other local government for the evaluation item having a distinctive feature in the target decision making entity. Thereby, it is possible to calculate a feature similarity degree that becomes higher as each of the evaluation values of the target decision making entity and the other decision making entities become higher for an evaluation item having a distinctive feature by simple calculation.

### Second Embodiment

Next, a description will be given of a second embodiment. A same sign is given to a same part of the information presentation apparatus according to the second embodiment as that of the information presentation apparatus 10 according to the first embodiment, and the detailed description will be omitted.

As illustrated in FIG. 1, an information presentation apparatus 210 according to the second embodiment includes the reception unit 11, the extraction unit 12, a calculation unit 213, and the presentation unit 14. A predetermined storage area in the information presentation apparatus 210 stores the evaluation information DB 21.

The calculation unit 213 calculates the feature similarity degree Tⱼ with the target local government a for each of the other local governments j other than the target local government a, for example, by the expression (1) in the same manner as the calculation unit 13 according to the first embodiment. At this time, the calculation unit 213 uses a deviation value S_{i, j} of the industry that is also a distinctive feature for the other local government j as S_{tak, j} in the expression (1) out of the deviation values S_{i, j} read from the evaluation information DB 21.

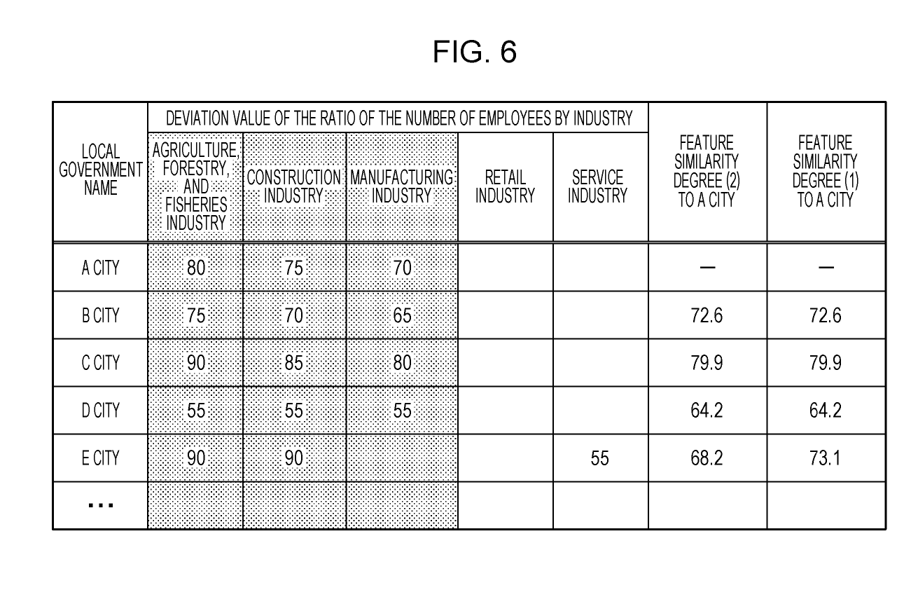

For example, in the case where the evaluation information DB 21 illustrated in FIG. 2 is used, the target local government a is A City, and L=3, as illustrated in FIG. 6, the agriculture, forestry, and fisheries industry, the construction industry, and the manufacturing industry are extracted as feature industries tₐₖ (k=1, 2, 3). Further, in FIG. 6, only the deviation values of three kinds of industries are illustrated in descending order of the deviation value S_{i, j} for each local government j, and the other deviation values expressed as blank. The calculation unit 213 uses only the deviation values t_{ak, j} (described deviation value in the shaded portion in FIG. 6) of the industries included in the top three kinds of industries of each local government for calculating the feature similarity degree Tⱼ.

Specifically, B City, C City, and D City have in common the agriculture, forestry, and fisheries industry, the construction industry, and the manufacturing industry as the top three industries in the deviation value, and these industries are all included in the feature industries tₐₖ of A City. Accordingly, the feature similarity degrees T_{B}, T_{C}, and T_{D} are calculated using the deviation values of the three industries. On the other hand, for E City, the feature similarity degree T_{E} is calculated using the deviation values of the agriculture, forestry, and fisheries industry, and the construction industry, which are included in the feature industry t_{Ak} of A City out of the top three industries, namely, the agriculture, forestry, and fisheries industry, the construction industry, and the service industry. That is to say, the deviation value of the service industry, which is not included in the feature industry t_{Ak} of A City, is not used for calculating the feature similarity degree T_{E} between A City and E City, and T_{E}=((80×90+75×90)/3)^{1/2}=68.2.

Accordingly, when M=3, unlike the first embodiment, the presentation unit 14 presents the first C City, the second B City, and the third E City to the user as reference local government names.

It is possible to realize the information presentation apparatus 210, for example, by the computer 40 illustrated in FIG. 4. The storage unit 43 of the computer 40 stores an information presentation program 250 that causes the computer 40 to function as the information presentation apparatus 210. The information presentation program 250 includes the reception process 51, the extraction process 52, the calculation process 253, and the presentation process 54. The storage unit 43 includes the evaluation information storage area 61.

The CPU 41 reads the information presentation program 250 from the storage unit 43, loads the information presentation program 250 into the memory 42, and executes the processes of the information presentation program 250 in sequence. The CPU 41 executes the calculation process 253 so as to operate as the calculation unit 213 illustrated in FIG. 1. The other processes are the same as those of the information presentation program 50 according to the first embodiment. Thereby, the computer 40 that executes the information presentation program 250 functions as the information presentation apparatus 210.

It is possible to realize the functions performed by the information presentation program 250 by, for example, a semiconductor integrated circuit, more specifically an ASIC, or the like.

The operation of the information presentation apparatus 210 according to the second embodiment is different from that of the first embodiment only in the feature similarity degree Tⱼ calculated in step S18 of the information presentation processing illustrated in FIG. 5, and thus the description thereof will be omitted.

As described above, with the information presentation apparatus 210 according to the second embodiment, the feature similarity degree is calculated using only the evaluation value of a feature evaluation item that is in common between the target decision making entity and the other decision making entities. Accordingly, it is possible to reduce the influence of an evaluation item that is not a distinctive feature for one of the decision making entities, and thus it is possible to calculate the feature similarity degree using an emphasized evaluation item having a more distinctive feature.

In the first embodiment and the second embodiment, the descriptions have been given of the case where an evaluation item (industry) having a high evaluation value (deviation value) is extracted as a distinctive feature evaluation item (feature industry). However, an evaluation item having a low evaluation value may be extracted as a distinctive feature evaluation item.

### Third Embodiment

Next, a description will be given of a third embodiment. A same sign is given to a same part of the information presentation apparatus according to the third embodiment as that of the information presentation apparatus 10 according to the first embodiment, and the detailed description will be omitted.

As illustrated in FIG. 1, an information presentation apparatus 310 according to the third embodiment includes the reception unit 11, an extraction unit 312, a calculation unit 313, and the presentation unit 14. A predetermined storage area in the information presentation apparatus 310 includes the evaluation information DB 21.

In the same manner as the extraction unit 12 according to the first embodiment, the extraction unit 312 extracts one or a plurality of evaluation items indicating the features of the target local government indicated by the target local government name notified from the reception unit 11 and the evaluation values of the evaluation items from the evaluation information DB 21. At this time, the extraction unit 312 also extracts an evaluation item having a low evaluation value as an evaluation item having a feature of the target local government.

Specifically, the extraction unit 312 calculates a reverse evaluation value that is produced by subtracting the evaluation value from twice the average value or the median value for the evaluation item having an evaluation value equal to or higher than the average value or the median value of the allowable evaluation values. The extraction unit 312 uses the reverse evaluation value as the evaluation value of the evaluation item. As in the present embodiment, when the deviation value is used as an evaluation value, for an industry having a deviation value S_{i, a} that is lower than 50, which is the average value, the reverse deviation value S′_{i, a} that is a value produced by subtracting a true deviation value from 100 is used. For example, when the deviation value S_{i, a}=20, the reverse deviation value S′_{i, a}=80.

Moreover, the extraction unit 312 extracts a predetermined number of or the number specified by the user via the input device of evaluation items in descending order of the evaluation value. The extraction unit 312 may extract evaluation items having an evaluation value equal to or higher than the predetermined value.

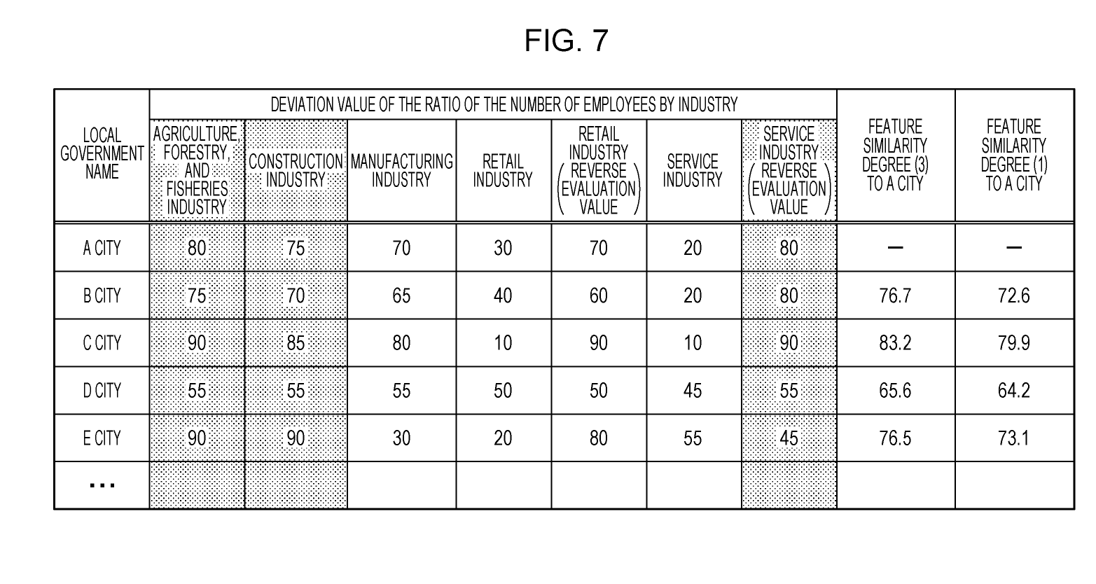

For example, when the target local government a is A City and the evaluation information DB 21 illustrated in FIG. 2 is used, as illustrated in FIG. 7, the extraction unit 312 calculates the reverse deviation value S′_{4, A}=70 by subtracting the actual deviation value S_{4, A}=30 from 100 for the retail industry having the deviation value S_{i, A} less than or equal to 50. In the same manner, the extraction unit 312 calculates the reverse deviation value S′_{5, A}=80 for the service industry having the deviation value S_{5, A}=20. When L=3, the extraction unit 312 extracts top three industries in descending order of the deviation value S_{i, A} or the reverse deviation value S′_{i, A} as the feature industries t_{Ak} of A City, which is the target local government a. Here, t_{A1}=the agriculture, forestry, and fisheries industry, t_{A2}=the service industry, and t_{A3}=the construction industry are extracted.

For the feature industry tₐₖ extracted by using the reverse deviation value S_{i, a} by the extraction unit 312, the calculation unit 313 calculates the feature similarity degree Tⱼ (shaded portion in FIG. 7) using the reverse deviation value S′_{tak, j} for the deviation value S_{tak, j} of the other local government j. For example, in the example in FIG. 7, the feature similarity degree T_{B} between A City and B City is calculated: T_{B}=((80×75+80×80+75×70)/3)^{1/2}=76.7.

It is possible to realize the information presentation apparatus 310, for example, by the computer 40 illustrated in FIG. 4. The storage unit 43 of the computer 40 stores an information presentation program 350 that causes the computer 40 to function as the information presentation apparatus 310. The information presentation program 350 includes the reception process 51, the extraction process 352, a calculation process 353, and the presentation process 54. The storage unit 43 includes the evaluation information storage area 61.

The CPU 41 reads the information presentation program 350 from the storage unit 43, loads the information presentation program 350 into the memory 42, and executes the processes of the information presentation program 350 in sequence. The CPU 41 executes the calculation process 352 so as to operate as the calculation unit 312 illustrated in FIG. 1. The CPU 41 executes the calculation process 353 so as to operate as the calculation unit 313 illustrated in FIG. 1. The other processes are the same as those of the information presentation program 50 according to the first embodiment. Thereby, the computer 40 that executes the information presentation program 350 functions as the information presentation apparatus 310.

It is possible to realize the functions performed by the information presentation program 350 by, for example, a semiconductor integrated circuit, more specifically an ASIC, or the like.

The operation of the information presentation apparatus 310 according to the third embodiment is different from that of the first embodiment only in the point that a reverse deviation value is used in the extraction of a feature industry in step S14 or S15 of the information presentation processing illustrated in FIG. 5, and the calculation of the feature similarity degree in step S18, and thus the description thereof will be omitted.

As described above, with the information presentation apparatus 310 according to the third embodiment, an evaluation item having a low evaluation value is handled as an evaluation item having a distinctive feature for the target decision making entity. Accordingly, it is possible to present information on the other decision making entities to be referenced in consideration of all the evaluation items. For example, in the example of the embodiment described above, it is possible to present an effective reference local government name deviation value for studying the measures that influence the entire industrial structure by using both the industries having high deviation values and the industries having low deviation values as feature industries.

Whether to use an evaluation item having a high evaluation value as the feature evaluation item, or to use an evaluation item having a low evaluation value as the feature evaluation item, or to use both as the feature evaluation item may be selectable by the user. In this case, the reception unit 11 ought to receive a selection by the user having been input via the input device and specify an extraction method and a calculation method for the extraction unit 312 and the calculation unit 313.

After extracting a feature evaluation item using a reverse evaluation value, in the same manner as the second embodiment, the feature similarity degree may be calculated by using the evaluation value of a feature evaluation item that is common to the target decision making entity and the other decision making entity or using only a reverse evaluation value.

### Fourth Embodiment

Next, a description will be given of a fourth embodiment. A same sign is given to a same part of the information presentation apparatus according to the fourth embodiment as that of the information presentation apparatus 10 according to the first embodiment, and the detailed description will be omitted.

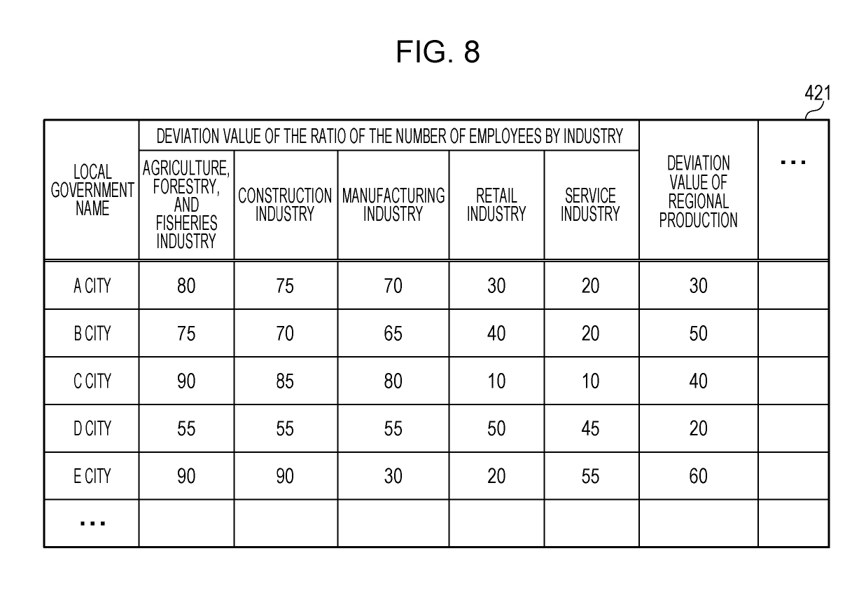

As illustrated in FIG. 1, an information presentation apparatus 410 according to the fourth embodiment includes the reception unit 11, the extraction unit 12, a calculation unit 413, and the presentation unit 14. A predetermined storage area in the information presentation apparatus 410 stores an evaluation information DB 421. As illustrated in FIG. 8, the evaluation information DB 421 includes an evaluation item other than the evaluation item used for calculation of the feature similarity degree in addition to the evaluation information DB 21 according to the first embodiment. FIG. 8 illustrates an example of including the other evaluation item, such as the deviation value of a regional production, or the like in addition to the deviation value of the ratio of employees by industry, which is used for calculating the feature similarity degree.

The calculation unit 413 calculates the feature similarity degree Tⱼ, in the same manner as the calculation unit 13 according to the first embodiment, and calculates a reference degree produced by adding the evaluation value of the evaluation item other than the evaluation item used for calculation of the feature similarity degree Tⱼ to the calculated feature similarity degree Tⱼ.

Specifically, the calculation unit 413 identifies an evaluation item (hereinafter referred to as a “problem item”) indicating a problem of the target local government from an evaluation item other than the evaluation item used for calculating the feature similarity degree Tⱼ in accordance with a predetermined rule. For example, the calculation unit 413 identifies an evaluation item having a deviation value less than or equal to a predetermined value as a problem item P out of evaluation items other than the evaluation item used for calculating the feature similarity degree Tⱼ. The calculation unit 413 calculates a reference degree Vⱼ that becomes higher as a local government j has a higher deviation value for the identified problem item P for each local government j. The calculation unit 413 calculates the reference degree Vⱼ using the deviation value S_{P, a} for the problem item P of the target local government a and the deviation value S_{P, j} for the problem item P of the other local government j, for example, by the following expression (2).

Vⱼ=(S_{P, j}−S_{P, a})+Tⱼ (2)

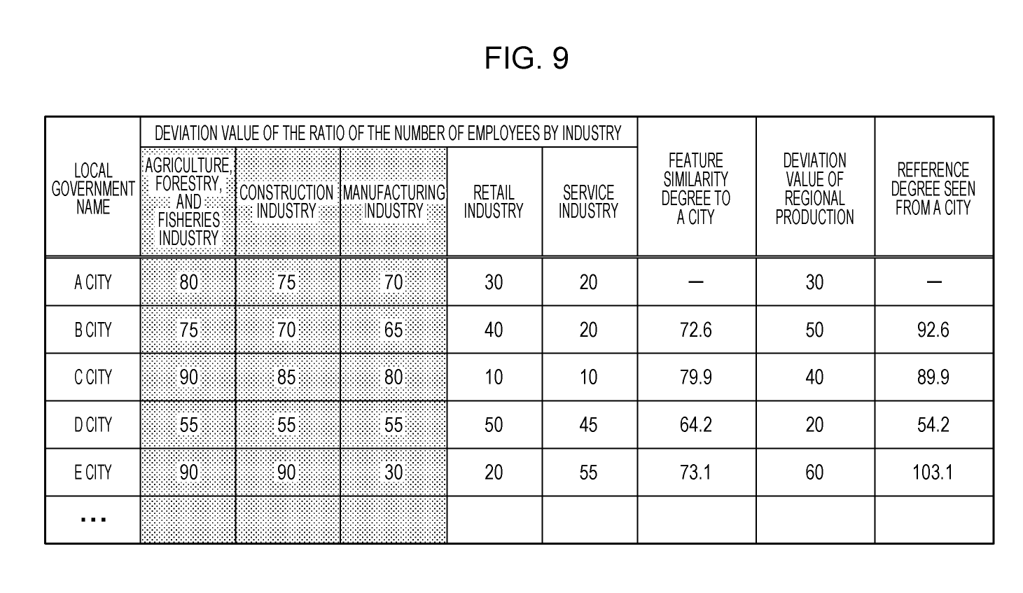

For example, when the target local government a is A City using the evaluation information DB 421 illustrated in FIG. 8, and the problem item P is identified as “regional production”, the reference degree V_{B} of B City with respect to A City becomes V_{B}=(50−30)+72.6=92.6 as illustrated in FIG. 9. In the same manner, for C City, D City, and E City, the reference degrees are calculated as V_{C}=89.9, V_{D}=54.2, and V_{E}=103.1 respectively. In the example in FIG. 9, the reference degree V_{E} of E City having a high deviation value for the problem item “regional production” of A City, which is the target local government a, becomes high.

The calculation unit 413 transfers the reference degree Vⱼ calculated for each local government j to the presentation unit 14.

The presentation unit 14 presents the other local government name having a reference degree Vⱼ, transferred from the calculation unit 413, equal to or higher than a predetermined value as a reference local government name to the user.

It is possible to realize the information presentation apparatus 410, for example, by the computer 40 illustrated in FIG. 4. The storage unit 43 of the computer 40 stores an information presentation program 450 that causes the computer 40 to function as the information presentation apparatus 410. The information presentation program 450 includes the reception process 51, the extraction process 52, a calculation process 453, and the presentation process 54. The storage unit 43 includes the evaluation information storage area 61 in which information constituting the evaluation information DB 421 is stored.

The CPU 41 reads the information presentation program 450 from the storage unit 43, loads the information presentation program 450 into the memory 42, and executes the processes of the information presentation program 450 in sequence. The CPU 41 executes the calculation process 453 so as to operate as the calculation unit 413 illustrated in FIG. 1. The other processes are the same as those of the information presentation program 50 according to the first embodiment. Thereby, the computer 40 that executes the information presentation program 450 functions as the information presentation apparatus 410.

It is possible to realize the functions performed by the information presentation program 450 by, for example, a semiconductor integrated circuit, more specifically an ASIC, or the like.

The operation of the information presentation apparatus 410 according to the fourth embodiment is different from that of the first embodiment only in the point that a reference degree is calculated in step S18 in the information presentation processing illustrated in FIG. 5, and a reference local government name is presented based on the reference degree in step S20 or step S21, and thus the description thereof will be omitted.

As described above, with the information presentation apparatus 410 according to the fourth embodiment, a reference degree produced by adding the evaluation value of the evaluation item other than the evaluation item used for calculation of the feature similarity degree to the feature similarity degree, and information on the other decision making entity to be referenced is presented based on the reference degree. Accordingly, it is possible to preferentially present the other decision making entity to be referenced in particular among the other decision making entities having similar features.

In the fourth embodiment, a description has been given of the case where the calculation unit 413 identifies a problem item based on the evaluation value of an evaluation item other than the evaluation item used for calculating the feature similarity degree. However, the present disclosure is not limited to this. An evaluation item specified by the user may be identified as a problem item. An evaluation item to be used for calculating the reference degree is not limited to a problem item of the target local government. It is possible to suitably select an evaluation item in accordance with an object of decision making by the target local government.

The user may be allowed to select any one of the calculation methods among the calculation methods of a feature similarity degree or a reference degree in each of the embodiments described above.

In each of the embodiments described above, descriptions have been given of the cases where the decision making entity is a local government, and the evaluation item is the ratio of the number of employees by industry. However, the present disclosure is not limited to this.

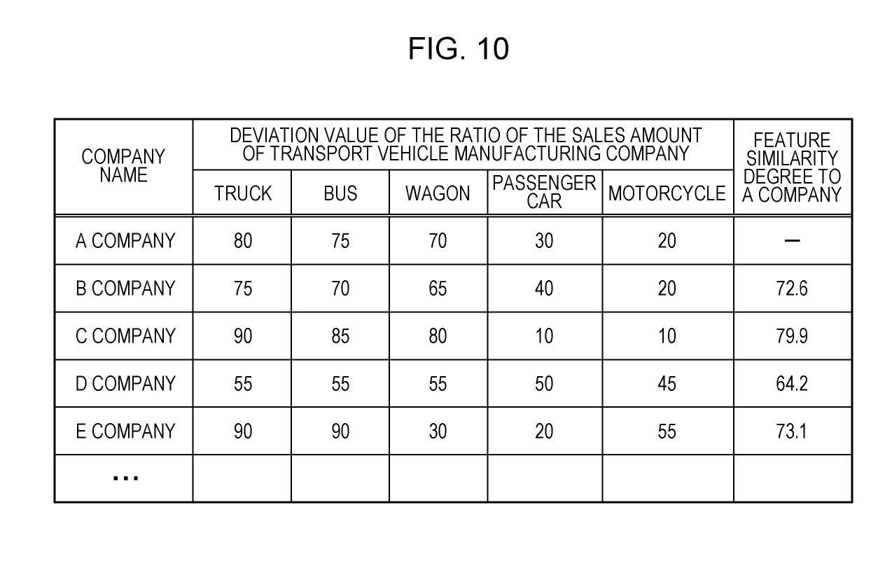

For example, as illustrated in FIG. 10, it is possible to apply the disclosed technique to the case where a company, which is an example of a decision making entity, searches for the other company to be referenced when the company makes a decision, such as at the time of developing a business plan, or the like. FIG. 10 illustrates an example in which the deviation value for each car model, such as a truck, a bus, or the like is used for the sales amount ratio of transport vehicles by transport vehicle manufacturing companies, and a car model is the evaluation item, and the deviation value of a sales amount ratio is the evaluation value. If it is assumed that A Company is a company to which information is presented, by extracting a car model having a high deviation value for A Company, a truck, a bus, and a wagon are extracted as feature car models of A Company. When a feature similarity degree is calculated with A Company for each company using the deviation values of the other companies for each feature car model of A Company, it is understood that the other companies having a similar feature to A Company are in the order of C Company, E Company, and B Company.

In each of the embodiments described above, a description has been given of the case where the feature similarity degree is calculated using the product of the evaluation value of the target decision making entity and the evaluation value of the other decision making entity for a feature evaluation item of the target decision making entity. However, the present disclosure is not limited to this. It is possible to calculate the feature similarity degree such that the feature similarity degree becomes higher as the both evaluation values become higher for the same feature evaluation item, for example, using the sum of the both evaluation values for each feature evaluation item, the total value of the products of that sum and a predetermined coefficient, or the like.

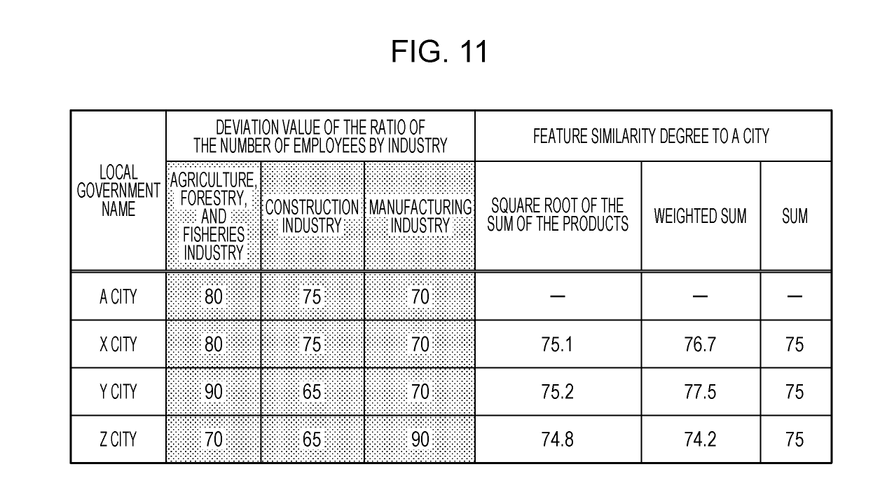

Referring to FIG. 11, a result of the comparison is illustrated for the calculation of a feature similarity degree among the case of using the product in the same manner as each of the embodiments described above, the case of using a weighted sum, and the case of using the sum. It is possible to calculate a weighted sum, for example, as illustrated by the following expression (3), by multiplying the sum of the deviation values of the target local government and the other target local government for each feature industry by a higher coefficient in descending order of the deviation value of the target local government. Here, for the sake of comparison with the other calculation methods, a feature similarity degree is produced by dividing the weighted sum by a predetermined fixed number (“12” here).

$${T}_{j} = \frac{{\sum }_{k = 1}^{L} \{ ( {S}_{{t}_{ak} , a} + {S}_{{t}_{ak} , j} ) \times ( L - k + 1 ) \}}{12} \qquad ( 3 )$$

For example, in the example in FIG. 11, it is possible to calculate a feature similarity degree T_{X} using the weighted sum of A City and X City as T_{X}=(((80+80)×3+(75+75)×2+(70+70)×1))/12=76.7.

As illustrated in FIG. 11, both A City and X City have the same deviation values for the respective feature industries. However, Y City has a higher deviation value for the agriculture, forestry, and fisheries industry, which is the most distinctive feature of A City. In either the case of using the product for calculating the feature similarity degree or the case of using a weighted sum, it is understood that Y City has a higher value than X City, and thus it is possible to preferentially present Y City, which has a more distinctive feature.

When the sum of the deviation values of the target local government for each feature industry and the other local government is simply used without multiplying a weight in accordance with the deviation value of the feature industry of the target local government, as illustrated in the “sum” field in FIG. 11, the same feature similarity degree is calculated for all the other local governments. Here, for the sake of comparison with the other calculation methods, the sum is produced by dividing by a predetermined fixed number (“6” here). That is to say, in the case of using the sum, in order to identify the other local government having a distinctive feature, a suitable weight has to be multiplied in accordance with the feature industry of the target local government. However, it is difficult to uniformly determine a suitable value of the weight. On the other hand, in the case of using the product, a parameter, such as a weight, or the like does not have to be set, and thus it is possible to easily calculate a suitable feature similarity degree.

In each of the embodiments described above, descriptions have been given of the cases where a reference local government name is presented. However, the other information related to the reference local government may be presented together. For example, a database ought to be maintained that includes presentation information including a successful case at the time of making a decision, a failure case, a budget allocation for a decision making matter, the contents of measures introduced by decision making, the organizational structure at the time of making a decision, or the like for each local government. Accordingly, it is possible to present the presentation information that is stored in association with the reference local government together with the reference local government name.

In the above descriptions, the descriptions have been given of the mode in which the information presentation programs 50, 250, 350, and 450, which are examples of the programs according to the disclosed techniques, are stored (installed) in the storage unit 43 in advance. However, the present disclosure is not limited to this. It is possible to provide the programs according to the disclosed techniques in the form stored in the storage medium, such as a CD-ROM, a DVD-ROM, a USB memory or the like.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An information presentation method for causing a computer to perform a process comprising:
among a plurality of evaluation items for each of a plurality of decision making entities, extracting one or a plurality of evaluation items that indicate features of a target decision making entity being a target specified by a user from an input device for information presentation;
for each of decision making entities other than the target decision making entity included in the plurality of decision making entities, calculating a feature similarity degree corresponding to the extracted evaluation items and becoming higher with an increase in a degree indicating a feature of the target decision making entity and each of the other decision making entities based on the evaluation value of the evaluation item; and
outputting information on the other decision making entity having the calculated feature similarity degree equal to or higher than a predetermined value to an output device.

2. The information presentation method according to claim 1,
wherein calculating as the feature similarity degree a value using a product of an evaluation value of the target decision making entity and an evaluation value of the other decision making entity for each of the extracted evaluation items.

3. The information presentation method according to claim 1,
wherein calculating the feature similarity degree based on an evaluation value of an evaluation item indicating a feature of the other decision making entities among the extracted evaluation items.

4. The information presentation method according to claim 1,
wherein when extracting the one or the plurality of evaluation items, for an evaluation item having an evaluation value less than or equal to an average value or a median value of allowable evaluation values for the target decision making entity, a reverse evaluation value produced by subtracting the evaluation value from twice the average value or twice the median value is used for an evaluation value of the evaluation item, and
among the extracted evaluation items, for an evaluation item having a reverse evaluation value, when calculating the feature similarity degree, the reverse evaluation value is used for an evaluation value of the evaluation item.

5. The information presentation method according to claim 1,
wherein when outputting the information on the other decision making entity, displaying the information in descending order of the feature similarity degree.

6. The information presentation method according to claim 1,
wherein outputting a reference degree based on the evaluation value of the evaluation item other than the evaluation item used for calculating the feature similarity degree with the feature similarity degree.

7. The information presentation method according to claim 1,
wherein the user is capable of selecting any one of the calculation methods from a plurality of calculation methods of the feature similarity degree.

8. An information presentation apparatus comprising:
a memory, and
a processor coupled to the memory and configured to perform a process including:
among a plurality of evaluation items for each of a plurality of decision making entities, extracting one or a plurality of evaluation items that indicate features of a target decision making entity being a target specified by a user from an input device for information presentation;
for each of decision making entities other than the target decision making entity included in the plurality of decision making entities, calculating a feature similarity degree corresponding to the extracted evaluation items and becoming higher with an increase in a degree indicating a feature of the target decision making entity and each of the other decision making entities based on the evaluation value of the evaluation item; and
outputting information on the other decision making entity having the calculated feature similarity degree equal to or higher than a predetermined value to an output device.

9. The information presentation apparatus according to claim 8,
wherein in the calculating, a product of an evaluation value of the target decision making entity and an evaluation value of the other decision making entity for each of the extracted evaluation items is calculated as a value of the feature similarity degree.

10. The information presentation apparatus according to claim 8,
wherein in the calculating, the feature similarity degree is calculated based on an evaluation value of an evaluation item indicating a feature of the other decision making entities among the extracted evaluation items.

11. The information presentation apparatus according to claim 8,
wherein in the extracting, when the one or the plurality of evaluation items are extracted,
for an evaluation item having an evaluation value less than or equal to an average value or a median value of allowable evaluation values for the target decision making entity, a reverse evaluation value produced by subtracting the evaluation value from twice the average value or twice the median value is used for an evaluation value of the evaluation item, and
among the extracted evaluation items, for an evaluation item having a reverse evaluation value, when calculating the feature similarity degree, the reverse evaluation value is used for an evaluation value of the evaluation item.

12. The information presentation apparatus according to claim 8,
wherein in the outputting, the information on the other decision making entity is displayed in descending order of the feature similarity degree.

13. The information presentation apparatus according to claim 8,
wherein in the outputting, a reference degree based on the evaluation value of the evaluation item other than the evaluation item used for calculating the feature similarity degree is outputted together with the feature similarity degree.

14. The information presentation method according to claim 8,
wherein any one of a plurality of calculation methods of the feature similarity degree is selectable by the user.

15. A non-transitory computer-readable storage medium storing an information presentation program causing a computer to perform a process comprising:
among a plurality of evaluation items for each of a plurality of decision making entities, extracting one or a plurality of evaluation items that indicate features of a target decision making entity being a target specified by a user from an input device for information presentation;
for each of decision making entities other than the target decision making entity included in the plurality of decision making entities, calculating a feature similarity degree corresponding to the extracted evaluation items and becoming higher with an increase in a degree indicating a feature of the target decision making entity and each of the other decision making entities based on the evaluation value of the evaluation item; and
outputting information on the other decision making entity having the calculated feature similarity degree equal to or higher than a predetermined value to an output device.

16. The storage medium according to claim 15,
wherein calculating as the feature similarity degree a value using a product of an evaluation value of the target decision making entity and an evaluation value of the other decision making entity for each of the extracted evaluation items.

17. The information presentation method according to claim 15,
wherein calculating the feature similarity degree based on an evaluation value of an evaluation item indicating a feature of the other decision making entities among the extracted evaluation items.

18. The information presentation method according to claim 15,
wherein when extracting the one or the plurality of evaluation items, for an evaluation item having an evaluation value less than or equal to an average value or a median value of allowable evaluation values for the target decision making entity, a reverse evaluation value produced by subtracting the evaluation value from twice the average value or twice the median value is used for an evaluation value of the evaluation item, and
among the extracted evaluation items, for an evaluation item having a reverse evaluation value, when calculating the feature similarity degree, the reverse evaluation value is used for an evaluation value of the evaluation item.

19. The information presentation method according to claim 15,
wherein when outputting the information on the other decision making entity, displaying the information in descending order of the feature similarity degree.

20. The information presentation method according to claim 15,
wherein outputting a reference degree based on the evaluation value of the evaluation item other than the evaluation item used for calculating the feature similarity degree with the feature similarity degree.
